(19) United States
(12) Patent Application Publication
(10) Pub. No.: US 2004/0227684 A1
(43) Pub. Date: Nov. 18, 2004

(54) Directional antenna apparatus

(76) Inventor: Ten-Long Deng, Chu Tung Chen (TW)

Correspondence Address: RABIN & Berdo, PC, 1101 14TH STREET, NW, SUITE 500, WASHINGTON, DC, 20005, US

(21) Appl. No.: 10/785,715

(22) Filed: Feb. 25, 2004

(30) Foreign Application Priority Data
Feb. 25, 2003 (TW) 92202932

(51) Int. Cl. H01Q 3/00

(52) U.S. Cl. 343/757

(57) ABSTRACT

A directional antenna apparatus comprises a pedestal, a directional plate, a printed circuit board and a digital transmission line. The directional plate is mounted on the pedestal with a universal joint, thereby the direction and the tilted angle of the directional plate can be adjusted arbitrarily toward to a wireless access point for receiving and sending radio frequency (RF) signals. The printed circuit board is fabricated in the pedestal and has decoding circuits defined thereon so as to decode the RF signals received by the directional plate to digital signals. And one end of the digital transmission line penetrating through the housing of the pedestal to connect with the printed circuit board. Another end of the digital transmission line is connected to a system host for conveying the decoded digital signals.

### FIELD OF THE INVENTION

The present invention relates to a directional antenna apparatus, and more particularly, to a directional antenna applied to desktop computers for decoding/encoding transmitted signals.

### BACKGROUND OF THE INVENTION

With rapid development and progress of electronic technology, the new generation of desktop computers can provide a powerful operation function and are widely used by enterprises and personal consumers. Moreover, local networks are constructed in most of companies or industries by installing cables and servers so as to effectively connect those computers and communicate or exchange various information and data. However, wired networks are expensive in design and layout, and construction and wiring of the wired networks frequently cause damage to rented office buildings. Further, the densely spread wire lines are too complicated to manage and maintain. Therefore, wireless networks have been used in many companies or industries to construct the desired inner networks.

Please refer to FIG. 1, the typical directional antenna 10 currently used is shown. The directional antenna 10 comprises a pedestal 102 and a directional plate 101 pivotally mounted on the pedestal 102. Because the directional plate 101 is capable of turning freely on the pedestal 102, users can adjust the direction and titled angle thereof arbitrarily and let the directional plate 101 toward the wireless access point as precise as possible, so as to promote the efficiency of receiving and transmitting radio frequency (RF) signals. On the rear side of the pedestal 102, a signal transmission line 103 is extended and connected to a computer host 12 for conveying the RF signals received by the directional plate 101 to the communication modules, such as net card or net chip, fabricated in the computer host 12. Then, the communication module can decode the RF signals and produce digital data or messages for usage by the computer host 12.

In general, in the directional plate 101 a highly concentrated arranged antenna array is fabricated, and the user can adjust the direction and tilted angle of the directional plate 101 to let the antenna array toward the wireless access point precisely. So the direction antenna can achieve the effect of concentrating signal with high gain and the benefit of transmitting and receiving wireless signals. However, it is required to choose the material with better shielding effect to fabricate the transmission line 103 for preventing it from noise interference around. Therefore, it is required to apply the transmission line with large diameter degrees, and that will cause higher cost.

Especially, for further promoting the transmitting efficiency of the directional plate 10, the transmission line 103 is usually prolonged as far as possible to provide more space for adjusting the positions of the directional antenna 10, so as to optimize the signal receiving effect. However, the prolonged transmission line 103 will cause the fabrication cost increase and raise the hazard of background noise interference. Therefore, how to overcome the above issues becomes a major concern in fabricating directional antenna 10 currently.

### SUMMARY OF THE INVENTION

It is therefore an objective of the present invention to provide a directional antenna with decoding circuits therein so as to decode the received RF signals and to produce digital signals, and then via a digital transmission line transfer the digital signals to the system host.

A directional antenna apparatus comprise a pedestal and a directional plate. The directional plate is mounted on the pedestal with a universal joint, capable of altering the direction and the tilted angle thereof. The directional plate has an antenna array fabricated therein for receiving signals sent by a wireless access point. Further, a printed circuit board is fabricated in the pedestal, having decode and encode circuits defined thereon so as to decode the RF signals received by the directional plate to digital signals and to encode the digital signals provided by a system host to the RF signals. And a RF signal transmission line is extending downward from the inside of the directional plate into the housing of the pedestal, connected between the antenna array and the printed circuit board, for conveying the RF signals received by the antenna array to the printed circuit board and conveying the RF signals encoded by the printed circuit board to the antenna array. Besides, a universal serial bus (USB) line is connected between the printed circuit board and a system host. One end of the USB line is connected through the housing of the pedestal to the printed circuit board, and another end of the USB line has a connector for directly plugging into a receiver fabricated on a housing of the system host, so as to convey the digital signals decoded by the printed circuit board to the system host and convey the digital signals provided by the system host to the printed circuit board.

### BRIEF DESCRIPTION OF THE DRAWINGS

The invention can be more fully understood by reading the following detailed description of the preferred embodiments, with reference made to the accompanying drawings, wherein:

FIG. 1 is a schematic view showing a directional antenna apparatus according to the prior art; and

FIG. 2 is a schematic view showing a directional antenna apparatus provided by the present invention.

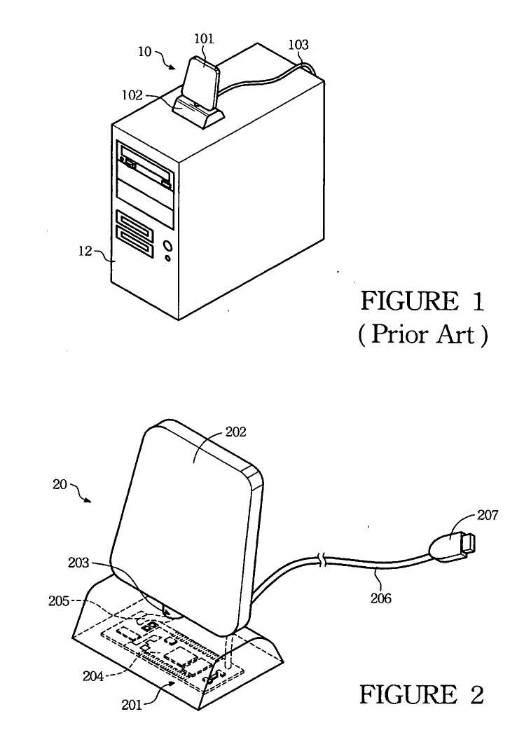

### DETAILED DESCRIPTION OF THE PREFERRED EMBODIMENT

The present invention disclosed a directional antenna apparatus. The directional antenna apparatus comprises a decoding circuit fabricated therein for decoding the received RF signals and producing the digital signals and can convey the digital signals via a digital transmission line to a computer host. The detailed description of the present invention is as follows.

Please refer to FIG. 2, the directional antenna apparatus 20 provided by the present invention is shown. The directional antenna apparatus 20 comprises a pedestal 201 and a directional plate 202. The directional plate 202 is mounted on the upper portion of the pedestal 201 with a universal joint, so users can turn or move the directional plate 202 to adjust the direction and tilted angle of the directional plate 202 arbitrarily. In a preferred embodiment, the directional plate 202 is joined to the pedestal 201 with a rotating axis 203 fabricated beneath the directional plate 202. And the rotating axis 203 can be connected with the upper portion of the pedestal 201 by means of an universal joint or a bi-directional axis, so as to allow users to adjust the direction and tilted angle of the directional plate 202.

The directional plate 202 connected onto the upper portion of the pedestal 201 can be turned by users arbitrarily to toward the wireless access point so as to receive or send wireless RF signals. In general, in the directional plate 202 also fabricated is a highly concentrated arranged antenna array, so when the directional plate 202 is moved or turned to aim at the position of the wireless access point, the signals received or sent thereof will be more centralized with higher gain, thereby promoting the performance of transferring and receiving wireless signals.

It is noted that in the pedestal 201 further fabricated is a printed circuit board 204. And on the printed circuit board 204 some decoding/encoding circuits are defined to decode the RF signals received by the directional plate 202 and to produce the digital signals. Besides, the printed circuit board can also encode the digital signals provided by the system host to produce the RF signals, and then sending the RF signals to the wireless access point via the antenna array fabricated in the directional plate 202.

For conveying the signals between the printed circuit board 204 and the directional plate 202, as shown in FIG. 2, a RF signal transmission line 205 is applied. One end of the RF signal transmission line 205 is connected to the antenna array in the directional plate 202, and another end is connected to the printed circuit board 204 via the rotating axis 203, thereby the RF signals received by the directional plate 202 can be conveyed to the printed circuit board 204 for decoding.

Besides, a digital transmission line 206 is applied to conveying the signals between the directional antenna apparatus 20 and the system host. As shown in FIG. 2, one end of the digital transmission line 206 penetrating through the housing of the pedestal 201 is connected to the printed circuit board 204, and another end thereof is prolonged outwardly and connected to the system host for conveying the digital signals handled by the decoding circuits. In a preferred embodiment, the digital transmission line can be chosen from the group of USB1.1, USB2.0 and IEEE 1394 lines. Generally, on the housing of the current host computer, usually one or more USB receivers are fabricated, so users can insert the front connector 207 of the digital transmission line 206 into the USB receiver of the system host.

The design of directional antenna apparatus disclosed in the present invention has following advantages:

(1) because the decoding/encoding circuits are fabricated in the pedestal of the directional antenna apparatus, for users there is no need to buy extra the communication module such as net cards of chips and no need to disassemble the computer host for fabricating the communication module. Relatively, just inserting the front end connector of the digital transmission line of the directional antenna provided in the present invention into the USB receiver of the computer host, the plug-in use can be obtained. Besides, when the directional antenna is broken, or when consumers want to use a new antenna of better performance, there is no need to disassemble the computer host and only pull out the USB connector of the directional antenna. Namely, the design of the present invention can provide consumers more convenience and utility.

(2) because the material of the digital transmission line such as the USB line is inexpensive, for the manufacturer the design provided by the present invention can reduce the cost of the RF signal transmission line. Further, the prolonged digital transmission line can provide consumers much more adjusting space to dispose the antenna apparatus or to adjust the directions and angles, thereby promoting the receiving performance of the wireless signals.

The invention has been described using exemplary preferred embodiments. However, it is to be understood that the scope of the invention is not limited to the disclosed embodiments. On the contrary, it is intended to cover various modifications aid similar arrangements. The scope of the claims, therefore, should be accorded the broadest interpretation so as to encompass all such modifications and similar arrangements.

What is claimed is:

1. A directional antenna apparatus comprising:
a pedestal;
a directional plate, connected onto said pedestal, wherein the direction and the tilted angle of said directional plate can be adjusted to toward to a wireless access point for receiving and sending signals;
a printed circuit board, mounted in said pedestal, having decode circuits defined thereon so as to decode said signals received by the directional plate; and
a transmission line, penetrating through a housing of said pedestal to connect with said printed circuit board, wherein one end of said transmission line is connected to a system host for conveying said signals.

2. The apparatus according to claim 1, wherein said transmission line is a universal serial bus (USB).

3. The apparatus according to claim 1, wherein said transmission line is chosen from the group of USB1.1, USB2.0 and IEEE 1394.

4. A directional antenna apparatus comprising:
a pedestal;
a directional plate, mounted on said pedestal with a universal joint, capable of altering the direction and the tilted angle thereof, wherein said directional plate have an antenna array fabricated therein for receiving signals sent by a wireless access point;
a printed circuit board, fabricated in said pedestal, having decode circuits defined thereon so as to decode said RF signals received by the directional plate to digital signals;
a RF signal transmission line, extending downward from the inside of said directional plate into the housing of said pedestal, connected separately with said antenna array and said printed circuit board, for conveying said RF signals received by said antenna array to said printed circuit board; and
a digital transmission line, connecting through the housing of said pedestal to said printed circuit board, wherein one end of said digital transmission line has a connector for plugging in a receiver fabricated on a housing of a system host, so as to convey said digital signals decoded by said printed circuit board to said system host.

5. The apparatus according to claim 4, wherein said digital transmission line is a USB bus.

6. The apparatus according to claim 4, wherein said digital transmission line is chosen from the group of USB1.1, USB2.0 and IEEE 1394.

7. A directional antenna apparatus comprising:
a pedestal;
a directional plate, mounted on said pedestal with a universal joint, capable of altering the direction and the tilted angle thereof, wherein said directional plate have an antenna array fabricated therein for receiving signals sent by a wireless access point;
a printed circuit board, fabricated in said pedestal, having decode and encode circuits defined thereon so as to decode said RF signals received by the directional plate to digital signals and to encode the digital signals provided by a system host to the RF signals;
a RF signal transmission line, extending downward from the inside of said directional plate into the housing of said pedestal, connected between said antenna array and said printed circuit board, for conveying said RF signals received by said antenna array to said printed circuit board and conveying the RF signals encoded by said printed circuit board to said antenna array; and
a universal serial bus (USB) line, wherein one end of said USB line is connected through the housing of said pedestal to said printed circuit board, and another end of said USB line has a connector for directly plugging into a receiver fabricated on a housing of a system host, so as to convey the digital signals decoded by said printed circuit board to said system host and convey the digital signals provided by said system host to said printed circuit board.
